(19) United States
(12) Patent Application Publication
(10) Pub. No.: US 2023/0096235 A1
(43) Pub. Date: Mar. 30, 2023

(54) INTELLIGENT WHOLISITIC CANDIDATE ACQUISITION

(71) Applicant: ACCENTURE GLOBAL SOLUTIONS LIMITED, Dublin 4 (IE)

(72) Inventors: Hansraj, Bangalore (IN); Hari Kumar Karnati, Bangalore (IN); Soundara Rajan, Bangalore (IN); Balaji Janarthanam, Chennai (IN)

(73) Assignee: ACCENTURE GLOBAL SOLUTIONS LIMITED, Dublin 4 (IE)

(21) Appl. No.: 17/491,335

(22) Filed: Sep. 30, 2021

(51) Int. Cl. G06Q 10/10; G06K 9/62; G06N 20/00

(52) U.S. Cl. CPC G06Q 10/1053; G06K 9/6231; G06K 9/623; G06K 9/6256; G06K 9/6262; G06N 20/00

(57) ABSTRACT

Systems and methods for facilitating candidate acquisition are disclosed. The systems may include a candidate acquisition orchestration engine. The engine may include a candidate engagement optimizer, which may receive, from a database storing profiles attributes of a plurality of candidates, an expanded dataset having one or more filtered attributes pertaining to a set of candidates from the plurality of candidates. The optimizer may receive, from an entity intending to engage at least one candidate, inputs associated with preferred parameters for the at least one candidate. The optimizer may process the expanded dataset and the entity inputs through a plurality of classifiers to generate candidate predictions. A bias identification engine may optimize the candidate predictions to remove inherent bias therein so as to generate, for each classifier, optimized candidate predictions. A stack classifier may process the optimized candidate predictions to generate final candidate predictions.

### BACKGROUND

Talent/Candidate Acquisition Process for candidate engagement includes various phases such as, for example, Demand Management, Requisition Management, Sourcing, Engagement, Screening, Scheduling, Interview, Offer Rollout, and Background Check. There is a significant amount of effort that goes in each of these phases. Furthermore, there is no wholistic view across all these phases, which makes the overall acquisition process cumbersome and inefficient. There may therefore be a need for a system that performs the entire acquisition process seamlessly with a wholistic view.

Contemporary talent acquisition systems struggle to manage all aspects of talent acquisition wholistically as these systems are generally focused on solving a single specific problem. For example, currently available tools are specific to a particular phase such as the screening phase or scheduling phase. However, none of the available tools cater to the requirements of all the phases of talent acquisition. Further, current talent acquisition systems function as match making systems instead of helping clients solve problems across all phases of talent acquisition.

### SUMMARY

An embodiment of present disclosure includes a system including a candidate acquisition orchestration engine. The candidate acquisition orchestration engine may include a candidate engagement optimizer operatively coupled with a processor. The candidate engagement optimizer may be configured to receive, from a database storing profiles attributes of a plurality of candidates, an expanded dataset having one or more filtered attributes pertaining to a set of candidates from the plurality of candidates. The candidate engagement optimizer may also be configured to receive, from an entity intending to engage at least one candidate, inputs associated with preferred parameters for the at least one candidate. The candidate engagement optimizer may process the received expanded dataset and the entity inputs through a plurality of machine-learning based classifiers to generate, for one or more candidates from the set of candidates, respective candidate predictions. The candidate engagement optimizer may optimize, using a bias identification engine, the candidate predictions generated by each classifier to remove inherent bias therein so as to generate, for each classifier, optimized candidate predictions. The candidate engagement optimizer may process, using a stack classifier, the optimized candidate predictions received from each of the respective classifiers, to generate final candidate predictions.

Another embodiment of the present disclosure relates to a method for facilitating candidate acquisition. The method may include a step of receiving, by a candidate engagement optimizer operatively coupled with a processor, from a database storing profiles attributes of a plurality of candidates, an expanded dataset having one or more filtered attributes pertaining to a set of candidates from the plurality of candidates. The method may include a step of receiving, by the candidate engagement optimizer, from an entity intending to engage at least one candidate, inputs associated with preferred parameters for the at least one candidate. The method may include a step of processing, by the candidate engagement optimizer, the received expanded dataset and the entity inputs through a plurality of machine-learning based classifiers to generate, for one or more candidates from the set of candidates, respective candidate predictions. The method may include a step of optimizing, by the candidate engagement optimizer, using a bias identification engine, the candidate predictions generated by each classifier to remove inherent bias therein so as to generate, for each classifier, optimized candidate predictions. The method may include a step of processing, by the candidate engagement optimizer, using a stack classifier, the optimized candidate predictions received from each of the respective classifiers, to generate final candidate predictions.

Yet another embodiment of the present disclosure relates to a non-transitory computer readable medium comprising machine executable instructions that may be executable by a processor to receive, from a database storing profiles attributes of a plurality of candidates, an expanded dataset having one or more filtered attributes pertaining to a set of candidates from the plurality of candidates. The processor may receive, from an entity intending to engage at least one candidate, inputs associated with preferred parameters for the at least one candidate. The processor may process the received expanded dataset and the entity inputs through a plurality of machine-learning based classifiers to generate, for one or more candidates from the set of candidates, respective candidate predictions. The processor may optimize, using a bias identification engine, the candidate predictions generated by each classifier to remove inherent bias therein so as to generate, for each classifier, optimized candidate predictions. The processor may process, using a stack classifier, the optimized candidate predictions received from each of the respective classifiers, to generate final candidate predictions.

### BRIEF DESCRIPTION OF DRAWINGS

Features of the present disclosure are illustrated by way of examples shown in the following figures. In the following figures, like numerals indicate like elements, in which:

FIG. 1A illustrates a block diagram of a system for facilitating candidate acquisition, according to an example embodiment of the present disclosure.

FIG. 1B illustrates a block diagram representation showing components of Candidate Engagement Optimizer (CEO) of FIG. 1A for facilitating candidate acquisition, according to an example embodiment of the present disclosure.

FIG. 2 illustrates a data flow diagram of the candidate acquisition process used in the candidate acquisition system, according to an example embodiment of the present disclosure.

FIG. 3 illustrates tabular data maintained in a data lake of the candidate acquisition system, according to an example embodiment of the present disclosure.

FIG. 4A illustrates a block diagram of a fair stack ensemble used in the candidate acquisition system of FIG. 1, according to an example embodiment of the present disclosure.

FIG. 4B illustrates an exemplary representation in the form of concentric circles showing various possibilities of variance and bias in final candidate prediction of FIG. 4A, according to an example embodiment of the present disclosure.

FIG. 4C illustrates an exemplary representation of Bi-Long Short-term Memory (Bi LSTM) model, according to an example embodiment of the present disclosure.

FIG. 4D illustrates an exemplary representation of Support Vector Machine (SVM) model, according to an example embodiment of the present disclosure.

FIG. 4E illustrates an exemplary representation of Light Gradient Boosting Machines (GBM) based model, according to an example embodiment of the present disclosure.

FIG. 4F illustrates an exemplary representation of BIA equation(s), according to an example embodiment of the present disclosure.

FIGS. 5A and 5B illustrate examples of the fair stack ensemble, according to an example embodiment of the present disclosure.

FIG. 6A illustrates a block diagram of a human bias processing performed as part of the fair stack ensemble of FIG. 4, according to an example embodiment of the present disclosure.

FIG. 6B illustrates exemplary tabular data displaying outputs processed by system of FIG. 1, according to an example embodiment of the present disclosure.

FIG. 7 illustrates a hardware platform for the implementation of the dynamic risk assessment system, according to an example embodiment of the present disclosure.

FIG. 8 illustrates a flow diagram for facilitating candidate acquisition, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “a” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

### Overview

Various embodiments describe providing a solution in the form of a system and a method for Intelligent Wholistic Talent Acquisition. Exemplary embodiments of the present disclosure have been described in the framework of Talent Acquisition Heuristic Orchestration Engine (hereinafter interchangeably referred to as TAHOE, candidate acquisition orchestration engine, or CAOE) which may be centred around a core Applicant Tracking System (ATS) systems for bringing together vendor, propriety Artificial Intelligence (AI) and automation solutions that can be applied to all talent acquisition opportunities for solving specific client problems. The CAOE may leverage the best of human and machines to create a modern service experience. The CAOE may automate and/or optimize various talent acquisition phases, such as screening, candidate engagement and other activities. The CAOE may utilize an Intelligent Wholistic Recruitment Optimizer (hereinafter interchangeably referred to as IWRO, candidate engagement optimizer (CEO) or optimizer) to leverage state of the art Artificial Intelligence (AI), Machine Learning (ML), Automation and/or Predictive Analytics. This may facilitate automation of unique work orchestration by leveraging expanded datasets across clients and domains, and rely on a predictive orchestration engine to optimize activities. The CEO may unlock critical business insights that identify requisition trends and early detection of potential candidates likely to fail background check. However, one of ordinary skill in the art will appreciate that the present disclosure may not be limited to such applications or advantages. The CEO may also determine areas of focus by leveraging predictive analytics for accelerating the candidate selection process. Several other advantages may be realized.

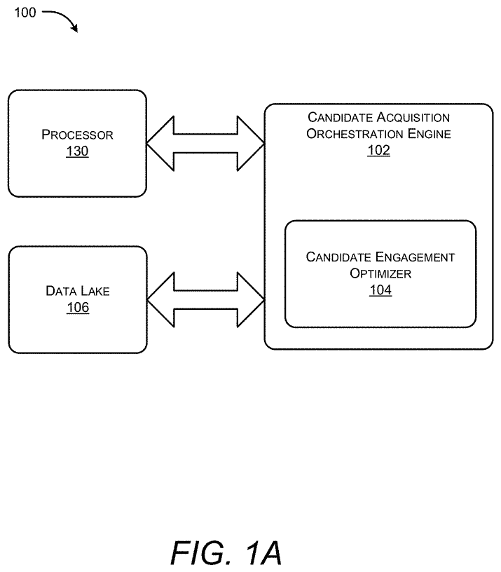

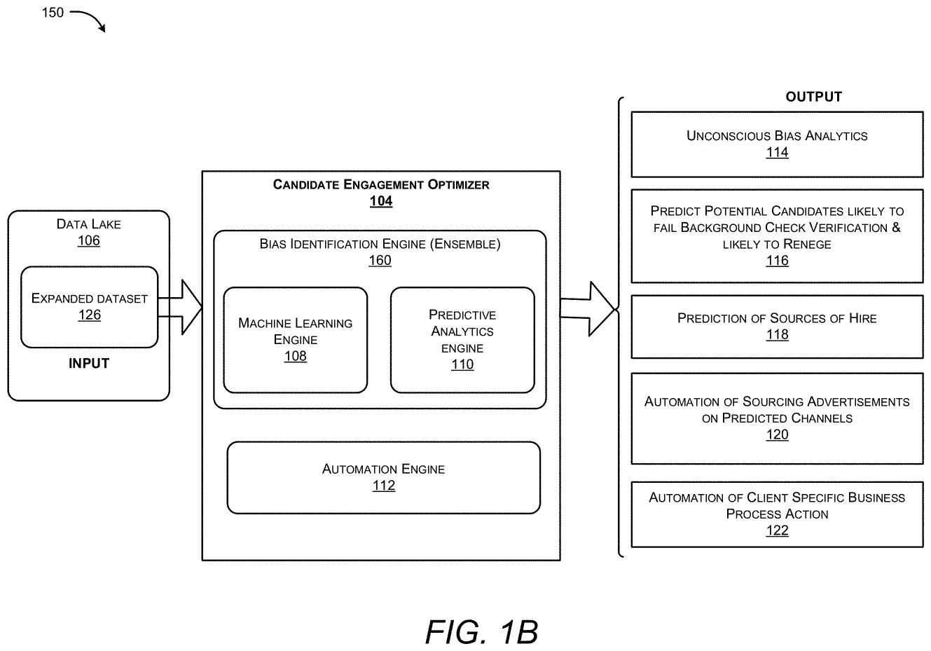

FIG. 1A illustrates a block diagram of a system 100 for facilitating candidate acquisition, according to an example embodiment of the present disclosure. In an example embodiment, the system 100 may use AI and unique automations to leverage unique expanded datasets across clients and domains. The system 100 may be configured to optimize various client activities that help them boost their productivity. The system 100 may unlock various business insights on biases and/or requisition trends. Some of these insights may be regular insights and some may be unique. The system 100 may help accelerate overall talent acquisition process. In an example embodiment, the system 100 may include a CAOE 102. The CAOE 102 may include a CEO 104 coupled to a processor 130 and a data lake 106. The CEO 104 may receive an expanded dataset from the data lake 106. The expanded dataset may include one or more filtered attributes pertaining to a set of candidates from the plurality of candidates. The CEO 104 of the system 100 may receive entity inputs from an entity intending to engage at least one candidate. The entity inputs may be associated with preferred parameters for the at least one candidate. In an example embodiment, the entity inputs may include at least one of a desired candidate profile, a diversity goal of the entity, an organization goal of the entity, and biases that the entity would desire to remove. Based on the received expanded dataset and the entity inputs, a plurality of machine-learning based classifiers, associated with the CEO 104, may generate respective candidate predictions for one or more candidates from the set of candidates. The CEO 104 of the system 100 may optimize the candidate predictions generated by each classifier to remove inherent bias therein so as to generate optimized candidate predictions for each classifier. The CEO 104 may utilize a stack classifier to process the optimized candidate predictions received from each of the respective classifiers to generate final candidate predictions.

The system 100 may be a hardware device including the processor 130 executing machine-readable program instructions to facilitate candidate acquisition. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor 130 may include, for example, microprocessors, microcomputers, microcontrollers, digital signal processors, central processing units, state machines, logic circuits, and/or any devices that manipulate data or signals based on operational instructions. Among other capabilities, processor 130 may fetch and execute computer-readable instructions in a memory operationally coupled with the system 100 (and the CEO 104) for performing tasks such as data processing, input/output processing, feature extraction, predictive analysis and/or any other functions. Any reference to a task in the present disclosure may refer to an operation being or that may be performed on the input data or expanded datasets.

In an embodiment, the system 100 may be configured to manage unconscious bias. The unconscious bias may be introduced in any talent acquisition phase where human element is involved. In an exemplary aspect, the unconscious bias may be related to gender, cast, creed, religion, ethnicity, race, skin color, interview bias, sexual orientation bias, source of hire bias, educational institution bias, location bias, and the like. In another exemplary representation, the unconscious bias can pertain to ethnicity which can be represented through bias based on nationality, language, race, cultural tradition, caste, creed, and color. Similarly, unconscious bias can pertain to diversity which can be represented through bias based on gender, orientation, physical abilities (people with disabilities), religion, weight, age, name, height, education background, and birthplace, for instance. Additionally, in an exemplary aspect, the unconscious bias can pertain to an anchor, which can be represented through bias based on salary expectations (if someone asked for lower, it should not indicate an unfit for job bias), someone having a one year of gap in employment, among other such biases. In another exemplary scenario, in a physical/virtual interview, an interviewee may potentially be assessed based on beauty (appearance), weak handshake, folded arms, or difficulty holding eye contact, among other such biases, which, through the proposed system, can be recorded/captured through interviewer's response to feed to system as to what happened and determine if these also contributed to nonverbal/unconscious bias.

The system 100 may reduce unconscious bias to an acceptable level in view of one or more client candidate acquisition objectives provided as the entity inputs to the system 100. For example, client candidate acquisition objectives may include having gender neutral workforce in next five years, quota based acquisition, such as twenty percent quota for LGBTQ and ten percent quota for persons with disability, any legal compliance objective, or a combination of policy based objectives and compliance objectives.

FIG. 1B illustrates a block diagram representation 150 illustrating components of CEO 104 of FIG. 1A for facilitating candidate acquisition, according to an example embodiment of the present disclosure. The CEO 104 may receive an input in the form of an expanded dataset 126. The expanded dataset may include one or more filtered attributes pertaining to a set of candidates from the plurality of candidates. In an example embodiment, the expanded dataset 126 may include at least one of a candidate application tracking system (ATS) data, data associated with qualification, interest, and availability of the candidate. The CEO 104 may also receive entity inputs from an entity intending to engage at least one candidate. The entity inputs may be associated with preferred parameters for the at least one candidate. The entity inputs may be associated with at least one of requirements for the candidates, one or more client candidate acquisition objectives, data received from other candidate acquisition systems, or tools, candidate profile, skill or industry requirement trends or projections, and/or any other relevant dataset.

In an example embodiment, the candidate acquisition systems, or tools may include, for example, AllyO, Hired Score, Funnel Analyzer, Workday, LinkedIn, Job portals, and other such tools. In an embodiment, the CEO 104 may include a bias identification engine (BIE) 160. The BIE 160 may include ensemble model based approach for generation of candidate predictions and further optimization for identification of bias and generation of optimized candidate predictions. In one example, the CEO 104 may include a fair stack ensemble. The fair stack ensemble may pertain to a supervised ensemble machine-learning algorithm that may include an optimal combination of a collection of prediction algorithms through stacking. In an example embodiment, the BIE 160 may include a machine learning (ML) engine 108 and a predictive analytics engine 110. As illustrated in FIG. 1B, the ML engine 108 may process the received expanded dataset 126 and the entity inputs (not shown in FIG. 1B) to obtain respective candidate predictions for one or more candidates from the set of candidates. The ML engine 108 may include a plurality of machine-learning based classifiers for obtaining the respective candidate predictions. The predictive analytics engine 110 of the BIE 160 may optimize the candidate predictions generated by each classifier to remove inherent bias therein. This step may lead to generation of optimized candidate predictions for each classifier. The BIE 160 may include a stack classifier to process the optimized candidate predictions received from each of the respective classifiers to generate final candidate predictions.

In another embodiment, the CEO 104 may leverage utilize expanded datasets developed using machine learning novel transformation functions on acquired datasets spanning multiple Client ATS to build a diverse profile. The processing and optimization by the BIE 160 may facilitate in determining several output/outcomes. One such output may include unconscious bias analytics 114. The term “unconscious bias” mainly pertains to an unintended/unrealized bias that may occur during manual candidate acquisition based on various aspects, such as, for example, gender, caste, creed, race, and the like. In an exemplary aspect, the unconscious bias may be related to nationality, language, cultural tradition, gender, caste, creed, color, race, source of hire, disability status, sexual orientation, physical abilities, weight, age, name, height, educational background, birthplace, salary expectations, employment history, interviewer, potential to renege, religion, ethnicity, skin color, interview, location, and background check, and the like. The BIE 160 facilitates minimization or complete removal of the unconscious bias, based on the requirements of the entity (via entity inputs) for fairer process of candidate acquisition. Another type of output may include prediction of potential candidates that may be likely to fail Background Check (BGC) verification and/or likely to renounce or renege an engagement offer (116). This output may be very crucial in reducing financial expenditure otherwise involved in losing a shortlisted candidate at a later stage for the reasons of background concerns and/or voluntary renouncement of the engagement offer by the shortlisted candidates. In another embodiment, the output may also facilitate to check bias involved in sources of hire (118). For example, if a source of hire, such as, for example, source X may be regularly referred for obtaining input/expanded datasets pertaining to the plurality of candidates, then a bias may be identified and respective predictions may be generated accordingly to remove the bias associated with the sources of hire X. This may facilitate to ensure that the other sources of hire are also utilized without partial preference to source X or other preferred sources.

In yet another embodiment, the output may also facilitate one or more automation aspects through an automation engine 112 of the CEO 104. The automation aspects may include automated sourcing of advertisements on predicted channels. For example, if 15 candidates may be required for an engagement offer related to Java implementation, the system 100 (through automation engine 112) may select a preferred source such as, for example, source Y to automatically post an advertisement for the engagement offer on the behalf of the entity. In an example embodiment, the automated posting of the engagement offer may be performed through predefined channel such as email communication, calls, messaging and other forms of communication. The automated posting may also be based on profile and/or requirements of the entity as provided in the entity inputs. In another embodiment, the system 100 may also facilitate automation of client specific business process action 122. This may include any specific automated action that the system 100 may perform related to communication with the candidate, entity, and others, without any manual intervention. The automation aspect may thus address unique wholistic business problem where there may be a market gap on solution. Non-limiting examples of such automation of client specific business process action 122 can include a) sending email to sourcing team with required details, OR b) opening up a ticket in a ticketing system and assigning to relevant team OR c) initiating a workflow in a client system by calling its APIs or method to invoke the workflow.

Further, the system 100 may be configured to train one or more machine learning classifiers 108 that may become more accurate over time at identifying candidates and providers likely to fail background check. This may in turn reduce time/cost efforts later in candidate acquisition phase.

In yet another embodiment, the CEO 104 may be configured to identify a set of candidates from a plurality of candidates based on one or more of matching of candidate skills with the preferred parameters for the at least one candidate, candidate profile, interest and availability of the candidate, source from where the candidate profile is received, and/or background check assessment of the candidate.

The data lake 106 may be a database storing profiles attributes of a plurality of candidates. In an alternate embodiment, the data lake 106 may also store customized dataset for utility in training the plurality of machine learning based classifiers. The data lake 106 may include data received from at least one of Client application tracking system (ATS), Funnel Analyzer (FA), Skill trend analyzer, Knowledge management platforms, Candidate crawlers, Job portals, and other such sources. The data lake 106 may include information about industry/domain trends, historical trends, next horizon skills, white-collar data, blue-collar data, skill predictions, and the other such information. Several of this data such as blue-collar data may be unstructured data formats, however several data components like white collar data may be structured data formats. For unstructured data formats, aspects of the present disclosure can leverage NLP (Natural Language Processing) to extract meaningful information by stemming, lemmatization & feature extraction by, for instance, TF-IDF or (Term Frequency (TF)-Inverse Dense Frequency (IDF)) and Word2vec, among any other extraction tool/model that can help in extracting meaningful information from unstructured data and saving it to data lake, which later helps in bias identification. In an exemplary aspect, tools such as Fairlearn; AI Fairness 360 toolkit (AIF360) can apply pre-trained models for gender based bias determination.

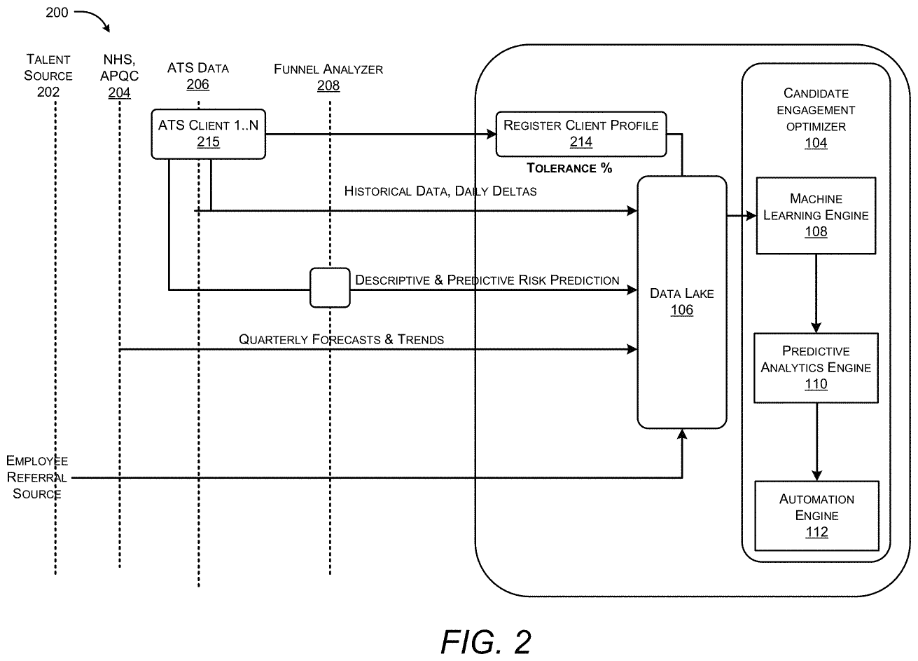

FIG. 2 illustrates a data flow diagram of the candidate acquisition process used in the candidate acquisition system, according to an example embodiment of the present disclosure. In an example embodiment, the data from a variety of sources, such as Client application tracking system (ATS) 206, Funnel Analyzer (FA) 208, Skill trend analyzer, Knowledge management platforms like APQC/NHS 204, Candidate crawlers, Job portals, referral sources, talent sources 202, client inputs, registered client profile 214, and the like, may be received by the data lake component 106 of the optimizer 104. The data from the variety of sources may be diverse and include historical data, daily updates, processed data, such as risk prediction, forecasts, trends, candidate information, such as candidate profile, client inputs, such as client objectives, and the like. In an example embodiment, the data lake 106 may include any type of data required for efficient working of the CEO 104 or any of its components.

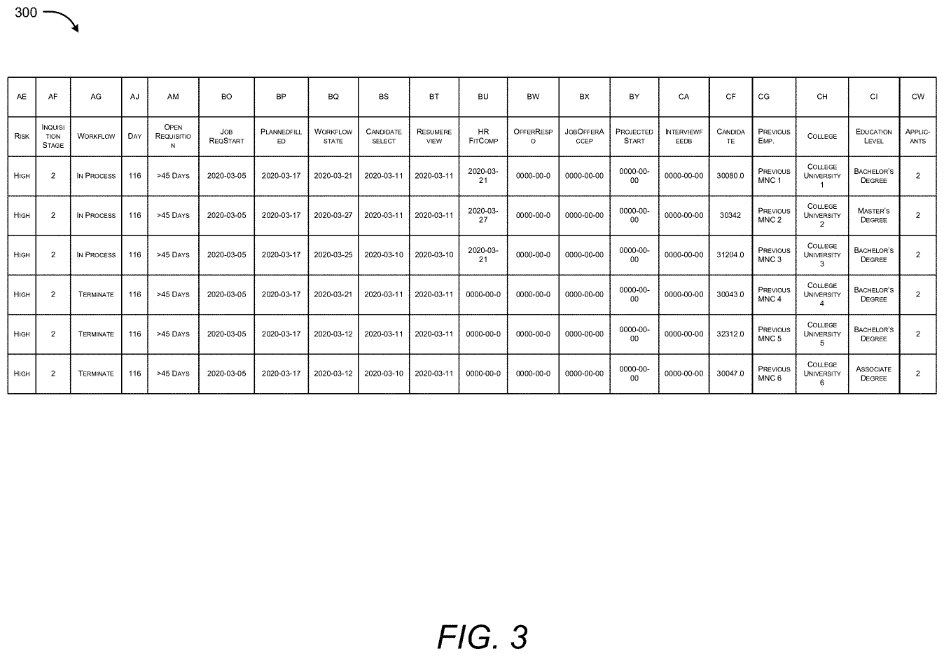

FIG. 3 illustrates an exemplary tabular data maintained in a data lake 106 of the candidate acquisition system, according to an example embodiment of the present disclosure. In an exemplary embodiment, the data may be in other formats besides tabular format. It may be appreciated that the data in the data lake and/or the expanded dataset may include various parameters related to risk, requisition, candidate profile, skill, trend, historical data, application parameters, eligibility parameters, client objectives, acquisition information, and the other such parameters.

Referring back to FIG. 2, and as per an example embodiment, at least a portion of the data in data lake 106 may be fed to the ML engine 108 to generate candidate predictions. The output from the ML engine 108 may be checked for disparity and/course correction to identify bias in the generated candidate predictions so as to optimize the predictions for removing bias therein. Outcome of the predictive analytics engine 110 may be fed to intelligent automation engine 112 for automating one or more tasks, as explained hereinabove in previous embodiments. For example, the predictive analytics engine 110 may predict that likelihood of finding skilled candidates for a particular technology is higher if a particular Job portal is used. Based on this prediction, the intelligent automation engine 112 may automate targeted advertising in line with one or more client objectives at the particular engagement portal. It may be appreciated that the automation is not restricted to mentioned examples. In an alternate embodiment, at least a portion of the data in data lake 106 may be fed to one or more models associated with the ML engine 108 and/or predictive analytics engine for training the one or more models.

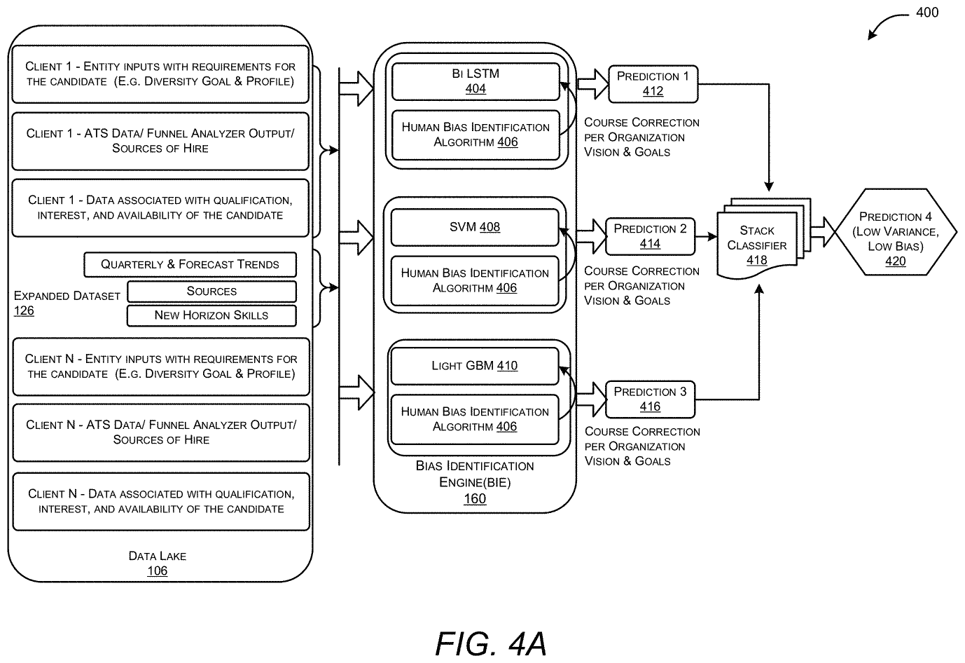

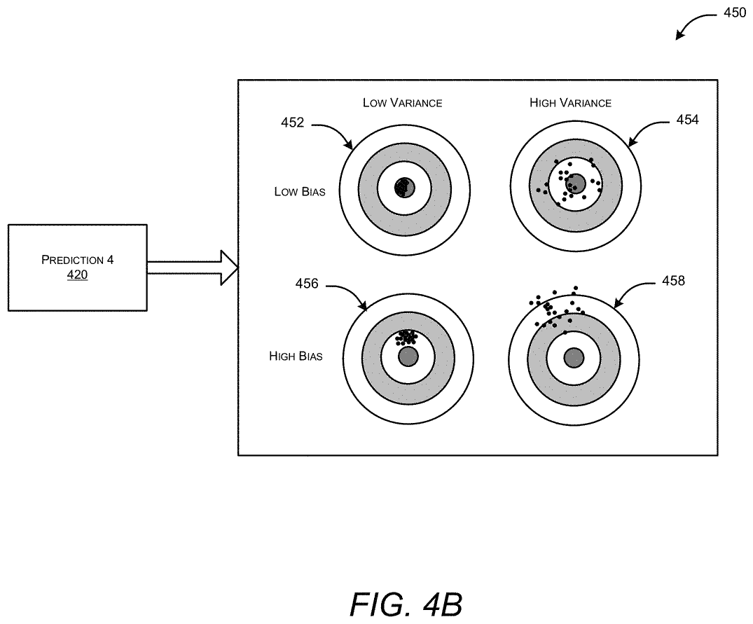

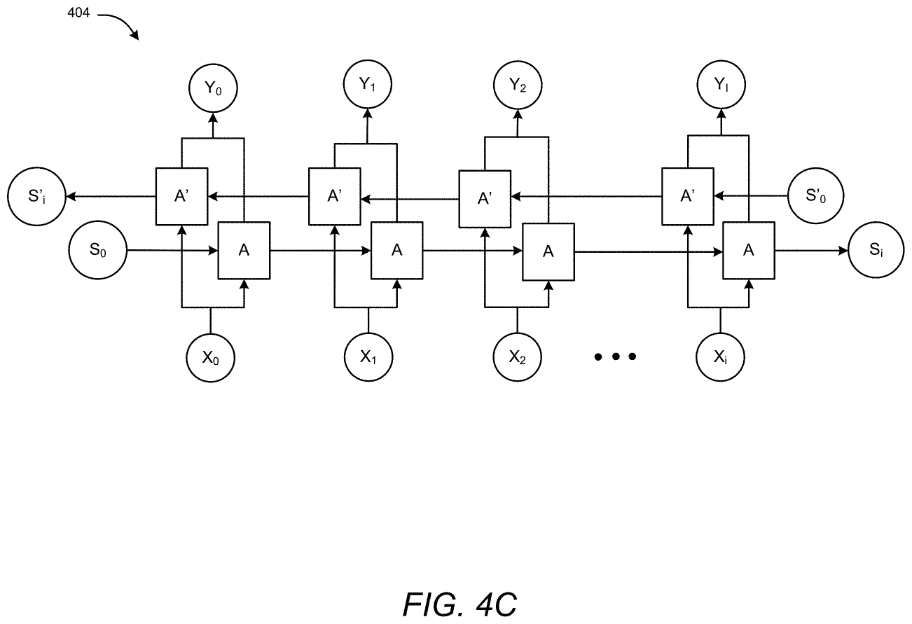

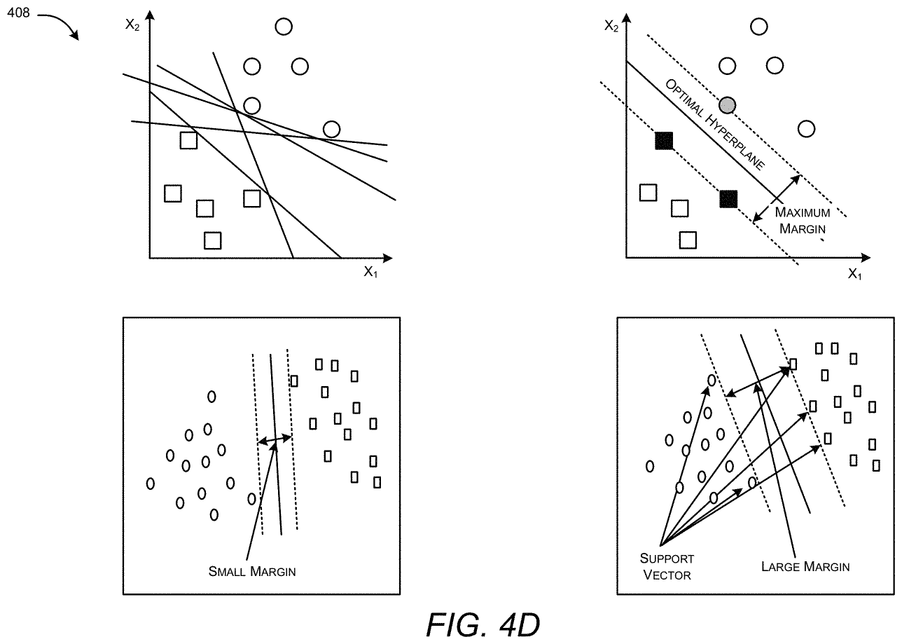

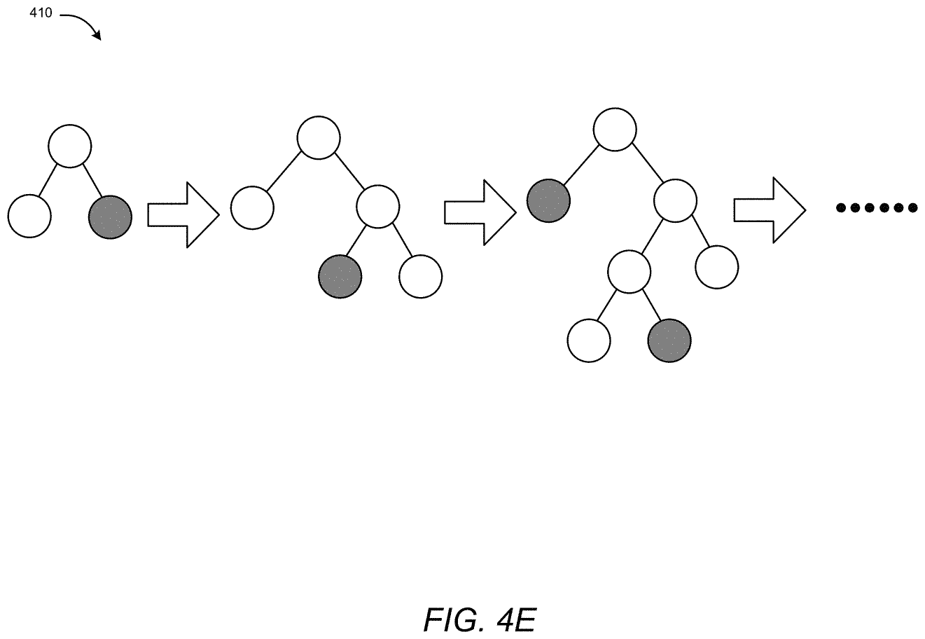

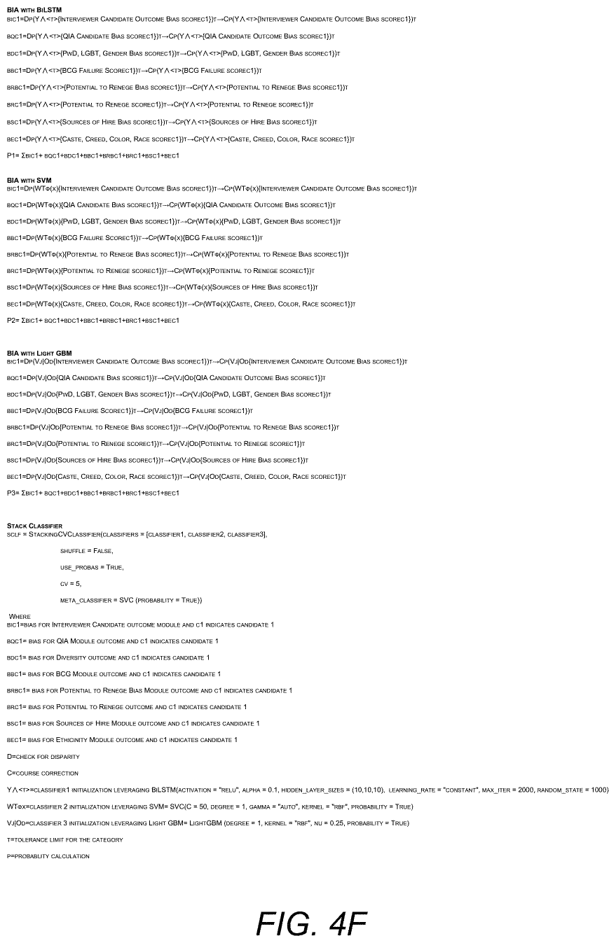

FIG. 4A illustrates a block diagram of a fair stack ensemble used in the candidate acquisition system of FIG. 1, according to an example embodiment of the present disclosure. As illustrated in FIG. 4A, expanded training data 402 or expanded dataset may be derived from one or more types of input data stored in a data lake 106 associated with system 100. For example, the data lake 106 may store one or more client inputs such as, for example, entity inputs covering requirements for the candidates. For example, the requirements may include the desired diversity goal and profile. For example, the requirements related to the diversity goal and profile may include an approximate percentage of candidates pertaining to lesbian, gay, bisexual, and transgender (LGBT), women candidates, disable candidates or people with disability (PwD) and other such groups. The data lake 106 may also store information or inputs received from ATS, funnel analyzer, various sources of hire and other such information. The inputs received from funnel analyzer may be in the form of transformed and filtered output of candidates as per engagement description. The data lake 106 may also store data associated with qualification, interest and availability of the candidate. One or more types of the above mentioned input data may be stored for one or clients (denoted as client 1 . . . client N). In addition, the input data may also include quarterly data and forecast tends, new horizon skills and other sources of information such as engagement portals that may cover one or more predictions related to overall skills trend, active engagement related updates and other such predictions or updates. Based on the received expanded training data (or expanded dataset), the fair stack ensemble of BIE 160 may produce one or more outputs without any unconscious bias based on one or more inputs. The one or more outputs may include prediction of source of hire, prediction of potential candidates likely to fail background check verification, prediction of potential candidates likely to renege, and the like. The fair stack ensemble may employ customized stacking and boosting architecture by eliminating unconscious human bias to increase predictive metrics of one or more machine learning models and lower variance/bias. The fair stack ensemble may use one or more trained machine learning models to uniquely identify one or more renege candidates based on one or more inputs from the input sources, such as engagement portals.

In an exemplary embodiment, stacking architecture used in the fair stack ensemble may rely on a plurality of machine learning models associated with the BIE 160 to produce a plurality of predictions. As illustrated in FIG. 4A, the fair stack ensemble of the BIE 160 may include multiple models/machine-learning based classifiers including Bi-Long Short-term Memory (Bi LSTM) model 404, Support Vector Machine (SVM) model 408 and Light Gradient Boosting Machines (GBM) based models 410. Each of the machine-learning based classifiers (404, 408 and 410) may generate candidate predictions that may be further optimized for removal of bias through a human bias identification algorithm (BIA) 406. The BIA 406 associated with the BIE 160 may remove bias associated with at least one of gender, caste, creed, race, source of hire, disability status, sexual orientation, interviewer, potential to renege, and background check. The BIA 406 executed by the BIE 160 may provide course correction to the respective classifiers by enabling bias removal while making the candidate predictions. The term “course correction” may refer to an alteration in approach/strategy of conventional algorithms/machine learning classifiers by utilizing BIA 406 to provide updated predictions, especially to generate optimized candidate predictions based on requirements of entity inputs and by removal of inherent bias. The course correction may mainly lead to training machine learning algorithm/classifiers over time to improve the accuracy of the algorithms and to reduce the bias. This also reduces the need for manual intervention and further removes the possibility of any unintended bias (such as unconscious bias in manual process). Further, the BIA 406 associated with the BIE 160 may also identify disparity in candidate predictions of each classifier, and may optimize the candidate predictions based on the entity inputs. The BIA 406 may evaluate historical values to identify the values that that may be omitted without adversely impacting accuracy. In an example embodiment, Bi LSTM 404 may generate a first prediction that may be fed to the BIA 406 to remove inherent bias for course correction as per the requirement/vision/goal of an entity (or an organization) to generate optimized prediction 1 (412). Similarly, the SVM 408 and Light GBM 410 may generate a second prediction and a third prediction respectively that may be fed to the BIA 406 to generate optimized prediction 2 (414) and optimized prediction 3 (416) respectively. The optimized predictions i.e. prediction 1 (412), prediction 2 (414) and the prediction 3 (416) may be processed using a stack classifier 418 to generate a final prediction i.e. prediction 4 (420) with low variance and low bias. The combination of low variance and low bias may be very crucial with respect to the consistency and reduced bias in the final candidate predictions. FIG. 4B illustrates an exemplary representation 450 in the form of concentric circles showing various possibilities of variance and bias in final candidate prediction 4 (420) of FIG. 4A, according to an example embodiment of the present disclosure. Each circle of the concentric circles may represent a certain group of humans (differentiated based on gender, caste, creed, LGBT, PwD and other such aspects). As illustrated in 452 of FIG. 4B, the final candidate predictions may be shown by the black dots. The final candidate prediction 4 (420), as obtained by the implementation described in FIG. 4A, may be considered to have low variance and low bias when the consistency of prediction is higher (lesser variance of dots that show consistent results) as well as the predictions are not concentrated in a certain portion/rings of circle (i.e. unbiased nature of the predictions). In an alternate embodiment as illustrated in 454 of FIG. 4B, a final candidate prediction may have low bias but high variance. In another alternate embodiment as illustrated in 456 of FIG. 4B, a final candidate prediction may have low variance but high bias as the predictions are concentrated in a certain area/limited to a certain group. In another alternate embodiment as illustrated in 458 of FIG. 4B, a final candidate prediction may have high variance and high bias. However, final candidate predictions need to have low variance and low bias (as illustrated in 452) for achieving greater consistency, accurate and fairer process of candidate acquisition.

Referring back to FIG. 4A, the three machine learning models (Bi-LSTM, SVM and Light GBM) along with the BIA 406 are used in the fair stack ensemble. In an alternate embodiment, the one or more machine learning models or classifiers may include at least one of an artificial intelligence model, a machine-learning model, a statistical model, a deep learning model and a predictive model. Additionally, or alternatively, the one or more machine learning models or classifiers may be selected from any of Long Short-term Memory (LSTM), Bi-Long Short-term Memory (Bi LSTM), Artificial Neural Network (ANN) model, Support Vector Machine (SVM), Reinforcement Learning (RL) model, Logistics Regression (LR) based model, Decision Tree (DT) based model, Vector Space Model (VSM) based model, Random Forest (RF) based model, xExtreme Gradient Boosted Trees based model, and Light Gradient Boosting Machines (GBM). However, it may be appreciated that the fair stack ensemble of the BIE 160 may not be limited to the mentioned models/machine-learning based classifiers and various other combinations of models/machine-learning based classifiers may be implemented in conjunction with the BIA 406 for generating optimized candidate predictions. The overall architecture or combination of models may help to reduce the variance and bias and provide accurate and consistent predictions.

In yet another exemplary embodiment, the one or more inputs to the fair stack ensemble may include any or a combination of inputs from one or more clients, such as tolerance, client goals, candidate profiles, sources of hire, FA output, ATS data, processed data from other systems/applications, such as, for example, AllyO, Hired Score, and the like, expanded data, such as forecast trends, talent sources, skill data, and the like, and/or any other data in the data lake 106.

FIG. 4C illustrates an exemplary representation of Bi-Long Short-term Memory (Bi LSTM) model 404, according to an example embodiment of the present disclosure. In an aspect, bidirectional recurrent neural networks (RNN) are configured so as to put two independent RNNs together, which structure allows the networks to have both backward and forward information about the sequence at every time step. Using bidirectional enables running of the inputs in two ways, one from past to future and one from future to such that using the two hidden states combined, information is preserved in any point in time from both past and future.

FIG. 4D illustrates an exemplary representation of Support Vector Machine (SVM) model 408, according to an example embodiment of the present disclosure. An exemplary objective of the support vector machine algorithm is to find a hyperplane in an N-dimensional space (N being the number of features) that distinctly classifies the data points.

FIG. 4E illustrates an exemplary representation of Light Gradient Boosting Machines (GBM) based model 410, according to an example embodiment of the present disclosure. In an aspect, LightGBM splits tree leaf-wise as opposed to other boosting algorithms that grow tree level-wise. It chooses the leaf with maximum delta loss to grow. Since the leaf is fixed, the leaf-wise algorithm has lower loss compared to the level-wise algorithm. FIG. 4E is an exemplary diagrammatic representation of Leaf-Wise Tree Growth.

FIG. 4F illustrates an exemplary representation of BIA equation(s), according to an example embodiment of the present disclosure.

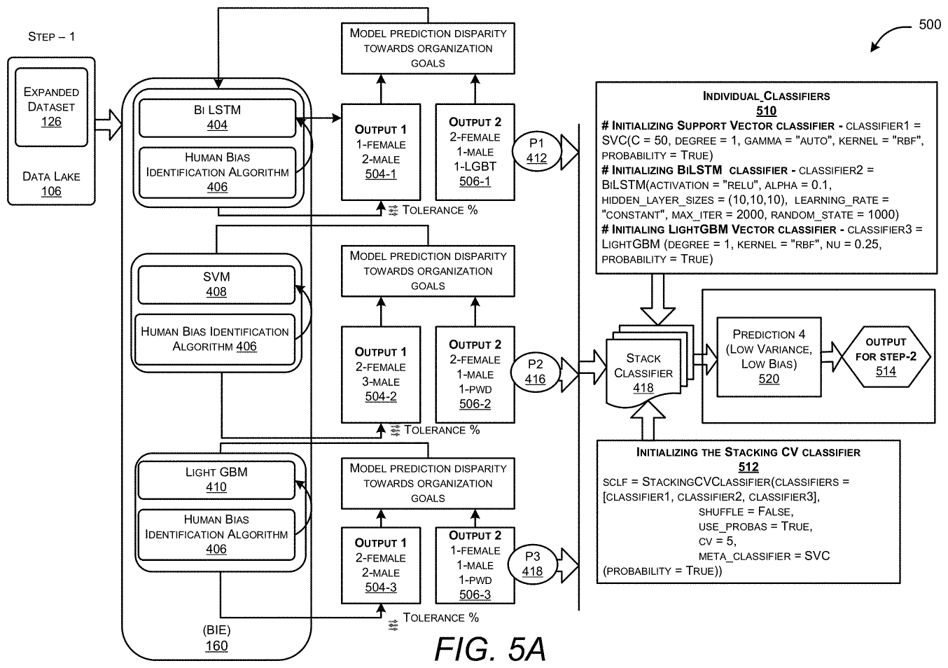

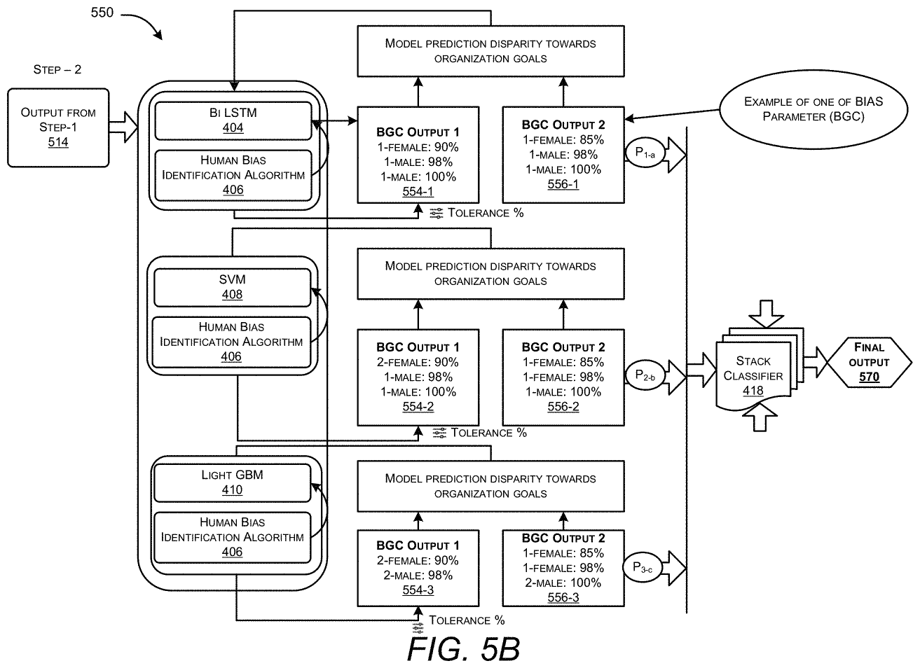

FIGS. 5A and 5B illustrate examples of the fair stack ensemble, according to an example embodiment of the present disclosure. As illustrated in FIGS. 5A and 5B, an expanded dataset 126 from the data lake 106 is fed to a plurality of machine learning based classifiers/models, each coupled with the BIA 406. Conventional open source packages such as, for example. Fair Learn, AI Fairness 360 toolkit (AIF360) and others may only identify gender based bias. The BIA 406 of the present disclosure leverages the bias in such conventional open source packages and expands the identification/removal of bias based on objectives of the entity (as provided in entity inputs). For example, the entity may intend for a candidate prediction by removal of bias that may be based on, for example, diversity ratio, LGBT Ratio, PwD, bias in qualified, interested, available candidates, interviewer outcome bias, bias in potential to renege, bias in potential to fail background check, bias in sources of hire, bias in caste, creed, race and other such parameters. As illustrated in 500 in FIG. 5A (similar to FIG. 4A), the implementation includes plurality of machine learning classifiers associated with the fair stack ensemble of the BIE 160. The machine learning classifiers include Bi LSTM 404, SVM 408, and Light GBM 410, where each of the plurality of machine learning models is coupled with BIA 406 (similar to implementation in FIG. 4A).

In an example embodiment, the overall technique of obtaining final candidate predictions for candidate acquisition may be performed based on expanded dataset and entity inputs through two steps i.e. step-1 as shown in 500 in FIG. 5A and step-2 as shown in 550 in FIG. 5B. The entity inputs may include organization goal such as, for example, intention to engage 40% female candidates, 20% LGBT candidates, 20% PwD candidates, and 40% male candidates. In an example embodiment, as illustrated in FIG. 5A, an output 1 (504-1) is produced by the Bi LSTM 404 which is course corrected as per the acceptable tolerance towards one or more goals (entity inputs) by the BIA 406 to produce output 2 (506-1), which is regarded as prediction ‘P1’ (412). For example, the entity inputs may include organization goal such as, for example, intention to engage 40% female candidates, 20% LGBT candidates, 20% PwD candidates, and 40% male candidates. Bi LSTM 404 may provide the output 1 (504-1) as, for example, 1 female, 2 male. In this case, the BIA 406 may identify the prediction disparity of the output 1 as per organization goal (entity inputs), to optimize the output 1 as per client diversity, such as, for example, 2 female, 1 male, 1 LGBT, which may be considered as optimized candidate prediction of Bi LSTM 404+BIA 406 i.e. P1 (412). The term “tolerance” may be considered as a feature of the system 100 applicable in cases wherein the candidate acquisition may fail to adhere to client diversity goals as per entity inputs and hence may be compensated by complying in a future timeline. For example, for July Month, if client diversity goal is not met by say X %, it will be compensated automatically in August month. In an example embodiment, an output 1 (504-2) is produced by the SVM 408 which is course corrected as per the acceptable tolerance towards one or more goals by the BIA 406 to produce output 2 (506-2), which is regarded as prediction ‘P2’ (416). For example, for the same entity inputs (or organization goals) as mentioned in previous example, SVM 408 may provide a predicted hiring output 1 (504-2) as, for example, 2 females, and 3 males. In this case, the BIA 406 may identify the prediction disparity of the output 1 as per organization goal (entity inputs), to optimize the output 1 as per client diversity, such as, for example, 1 female, 1 male and 1 PwD which may be considered as optimized candidate prediction of SVM 408+BIA 406 as P2 (416). Similarly, output 1 (504-3) is produced by the Light GBM 410 which is course corrected as per the acceptable tolerance towards one or more goals by the BIA 406 to produce output 2 (506-3) which is regarded as prediction ‘P3’ (418). For example, for the same entity inputs (or organization goals) as mentioned in previous example, Light GBM 410 may provide a predicted hiring output 1 (504-3) as, for example, 2 females and 2 males. In this case, the BIA 406 may identify the prediction disparity of the output 1 as per organization goal (entity inputs), to optimize the output 1 as per client diversity, such as, for example, 2 females, 1 male and 1 PwD which may be considered as optimized candidate prediction of Light GBM 410+BIA 406 as P3 (418). Each of the predictions ‘P1’ 412, ‘P2’ 416, and ‘P3’ 418 may be fed to one or more stack classifiers 420 to produce a low variance and low bias prediction 4 (520). The low variance and low bias prediction 520 may be regarded as final output (514), which may be used in step-2 (FIG. 5B) as an input. In an example embodiment, the stack classifier 418 may include ensemble of individual classifiers 510 pertaining to the initialization of Bi LSTM, SVM and Light GBM classifiers. Further, as shown in 512, the stack classifier 420 may include sequence initialization of cross-validation (CV) classifier for improved accurate prediction having low variance and low bias.

As illustrated in 550 of FIG. 5B, output 514 from step 1 depicted in FIG. 5A is fed as an input in step-2 to the fair stack ensemble implementation (BIE 160) for further processing with respect to one or more bias objectives (BGC). BIA may expand identification of bias to client objectives, such as Diversity Ratio, LGBT Ratio, PwD (People with Disability), bias in Qualified, Interested, Available, and the like, Interviewer outcome bias, bias in potential to renege, bias in potential to fail background check, bias in sources of hire, bias in caste, creed, race, and/or any other relevant parameters. For example, each block in the illustration in FIG. 5B provide probability of candidates who may be likely to fail a background check (BGC) and/or probability of candidates who are likely to renege. For example, based on the output from step-1, the Bi LSTM 404 may provide an output 1 (554-1) indicating 1 female and 2 male candidates with prediction probability of candidate, who may be likely to pass the background check and likely to renege, as shown in Table-1 below. For example, prediction probability to pass the background check may be 90% for the female candidate and 98% and 90% for the male candidates 2 and 3 respectively. Similarly, the prediction probability to renege may be 2% for the female candidate 1, and 1% and 0% for the male candidates 2 and 3 respectively. BIA 406 may then identify the model prediction disparity in source of hire, background check and number of updates/activity in job portal. BIA 406 may also optimize the model prediction as per client requirements by eliminating or reducing one or more bias. Based on above mentioned aspects, the BIA 406 may optimize the output to obtain output 2 (556-1) pertaining to optimized candidate prediction P1-a as shown in FIG. 5B, as seen in Table 2 below. As observed in Table 2, the probability of passing background check gets reduced for candidate to 85% (from 90%), which may be result of identifying model prediction disparity, for example, the source of hire.

TABLE 1
Output 1 (554-1) from Bi LSTM 404 (step-2)

| | | Probability of | |
|---|---|---|---|
| | | Background | Probability |
| Sex | Candidate | Check passing | of Renege |
| Female | Candidate 1 | 90% | 2% |
| Male | Candidate 2 | 98% | 1% |
| Male | Candidate 3 | 100% | 0% |

TABLE 2
Output 1 (556-1) from BIA 406 (step-2)

| | | Probability | | |
|---|---|---|---|---|
| | | of Back- | | |
| | | ground | | |
| | | Check | Probability | |
| Sex | Candidate | passing | of Renege | Comments |
| Female | Candidate 1 | 85% | 2% | Adjusted after |
| | | | | eliminating |
| | | | | the bias from |
| | | | | source of |
| | | | | hire. This |
| | | | | indicates |
| | | | | “Course |
| | | | | Correction” |
| | | | | where step1 |
| | | | | BCG passing |
| | | | | probability |
| | | | | was 90% |
| | | | | (prediction 1) |
| | | | | and post |
| | | | | BIA course |
| | | | | correction, |
| | | | | the updated |
| | | | | value is |
| | | | | now 85% |
| | | | | (prediction 2) |
| Male | Candidate 2 | 98% | 1% | |
| Male | Candidate 3 | 100% | 0% | |

Similar process may be performed for the remaining models associated with BIA as depicted in FIG. 5B. The SVM 408 may generate an output 1 (554-2) which may be optimized by the BIA 406 to obtain output 2 (556-2) pertaining to optimized candidate prediction P2-b. The Light GBM 410 may generate an output 1 (554-3) which may be optimized by the BIA 406 to obtain output 3 (556-3) pertaining to optimized candidate prediction P3-c. It may be appreciated that the above described implementation provides an example embodiment bearing background check and renege as a bias parameter, but the present implementation can be expanded to other bias parameters that may be crucial to the entity. Based on prediction P1-a, P2-b and P3-c, the stack classifier 418 generates the final output 570 of Step 2 pertaining to the final candidate prediction of potential candidate based on client diversity goals considering potential renege and background check passing.

In an example embodiment, the bias related to BGC, renege may vary with various scenarios. For example, a highly skilled candidate may be qualified and receive an offer. However, the probability of likelihood to renege may be due to various reasons such as, for example, pay scale offered may be at par or below industry standard, grade of the candidate, interest and availability, high demand of skill, lack of supply but high demand of candidates, greater requirement of talent update for the candidate on job portals, and other such reasons. The likelihood of renege may also vary per requisition, level, grade, skill, location, onsite, offsite, blue collar, white collar, and the like. Using an expanded training dataset, the system 100 can predict whether a candidate is likely to renege, and also, if the results predicted has bias in potential to renege. Further, with expanded dataset, a rich database may be established across industry. In addition, the system 100 can also identify bias that may be based on manual perception. For example, a candidate who may not be from a reputed college may qualify with high grade but may get rejected in an interview. The BIA 406 can identify and project likely bias by interviewer as per acceptable tolerance level, client organization goals, basis Interviewer past results and current candidate prediction model via available updates received from sources (for example, talent crawler), industry trends, demand, supply, location (e.g., tier2 city), and other such basis. The present disclosure may not be limited to the mentioned aspects of bias and several other examples/embodiments covering other types of bias may be identified and removed by the system to provide fairer and unbiased candidate predictions.

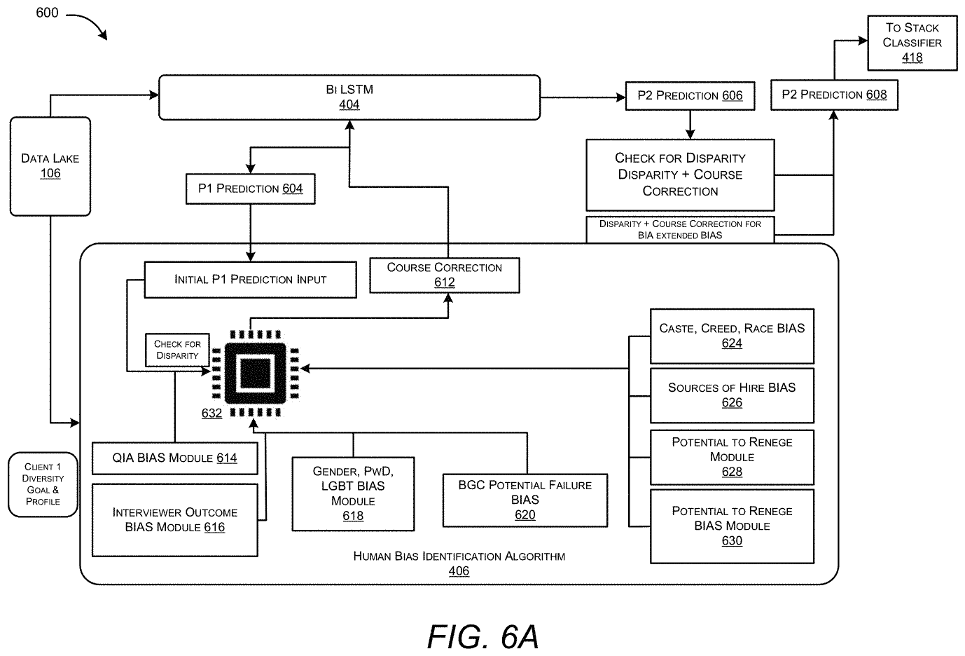

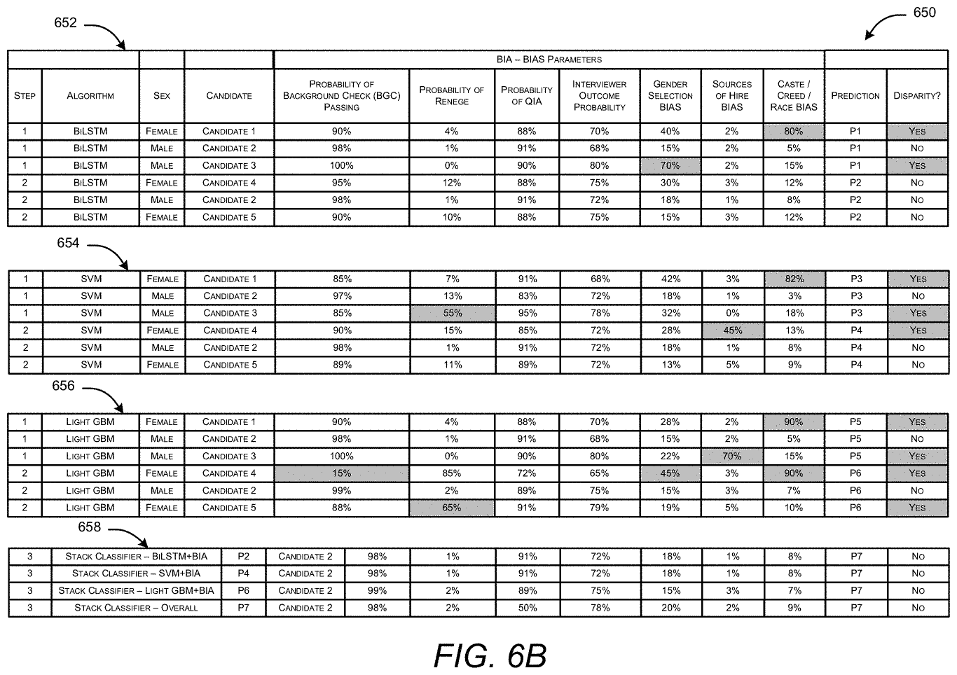

FIG. 6A illustrates a block diagram of a human bias processing performed as part of the fair stack ensemble of FIG. 4, according to an example embodiment of the present disclosure. In an exemplary embodiment, the BIA performs human bias processing. The BIA 406 may receive inputs from a machine learning model, such as Bi LSTM 404 and data lake 106. The inputs may include initial ‘P1’ prediction 604 fed to the BIA 406. The initial prediction 604 is checked for disparity at a central module 632 that may execute the BIA 406. The central module 632 may optimize the initial ‘P1’ prediction 604 through one or more modules, such as, for example, QIA bias module 614, interviewer outcome bias module 616, bias module 618 pertaining to bias identification/removal for gender, LGBT, PwD related bias and module 620 for background check related failure. The QIA bias module may identify bias pertaining to qualified, interested and available candidates. The central module 632 may also optimize the initial ‘P1’ prediction 604 through other modules such as, for example, the module 624 assessing bias related to caste, creed, race, and other such aspects, module 626 assessing bias related to sources of hire, module 628 assessing potential of candidates to renege and module 630 that may assess the bias towards the probability of renege. Various other modules can also be used based on the bias parameters/aspects pertaining to at least one of client goals, profile, tolerance, interviewer bias, gender bias, disability bias, LGBT bias, ethnicity bias, cast bias, creed bias, race bias, skin color bias, sources of hire, potential to renege, and the like. Based on optimization by the BIA 406, the central module 632 may process the received inputs and provide a course correction 612 to the machine learning model (Bi LSTM 404). The machine learning model may use the received course correction 612 to produce a refined prediction ‘P2’ 606. The prediction 606 may be further checked for disparity/course correction to obtain optimized prediction P2 (608), which is then provided to the stack classifier 420. In an example embodiment, the BIA 406 or associated modules may identify bias by at least one of a natural language processing (NLP) technique, feature extraction and other such processes.

In an exemplary embodiment, the BIA 406 may remove bias associated with any or a combination of gender, caste, creed, race, source of hire, disability status, sexual orientation, interviewer, potential to renege, and background check. The BIA 406 may provide one or more course corrections to an associated machine learning model or classifiers by enabling bias removal while making the candidate predictions. The BIA 406 may also be configured to identify disparity in candidate predictions of each classifier and optimize the candidate predictions based on one or more entity inputs. The entity inputs may include desired candidate profile, diversity goal of the entity, organization goal of the entity, and biases that the entity would desire to remove. In an exemplary embodiment, the BIA 406 may be associated with a machine learning model, which can be trained using data in data lake and/or other sources.

FIG. 6B illustrates exemplary tabular data 650 displaying outputs processed by the BIA 406 the system 100, according to an example embodiment of the present disclosure. The tabular data 650 includes multiple tables 652, 654 and 656 corresponding to the outputs generated by BIA 406. The tabular data 650 displays type of algorithm, candidate details, bias parameters, generated prediction and disparity in prediction. As shown in table 652, the first 3 rows indicate output generated in step 1 of Bi LSTM (404)+BIA (406) (similar to embodiment described in FIG. 5A) for candidates 1, 2 and 3. It can be observed that the prediction outcome of step-1 includes disparity for candidates 1 and 3 based on bias of caste/creed/race and gender selection bias (as per entity inputs) respectively (as shown in grey highlight), but no disparity is observed for candidate 2. Therefore, based on the prediction outcome of step-1, in the next step-2 (similar to the embodiment FIG. 5B), only the candidate 2 is retained, whereas the other candidates 1 and 3 are replaced with candidates 4 and 5 (as shown in last 3 rows of table 652). At the end of step-2, as seen in last 3 rows of table 652, no disparity is observed in case of candidates 1, 4 and 5. Similarly, the first 3 rows in table 654 indicate output generated in step 1 of SVM (408)+BIA (406) (similar to embodiment described in FIG. 5A) for candidates 1, 2 and 3. The step-1 indicates disparity in candidates 1 and 3 based on bias of caste/creed/race and probability to renege respectively (as shown in grey highlight), but no disparity is observed for candidate 2. Therefore, based on the prediction outcome of step-1, in the next step-2 (similar to the embodiment FIG. 5B), only the candidate 2 is retained, whereas the other candidates 1 and 3 are replaced with candidates 4 and 5. At the end of step-2, as seen in last 3 rows of table 654, disparity is observed only in case of candidate 4 based on bias due to sources of hire. Similarly, the first 3 rows in table 656 indicate output generated in step 1 of Light GBM (408)+BIA (406) (similar to embodiment described in FIG. 5A) for candidates 1, 2 and 3. The step-1 indicates disparity in candidate 3 only, and hence in step-2, candidate 3 is replaced with candidate 5. At the end of step-2, as seen in last 3 rows of table 656, disparity is observed in case of candidates 1 and 5. The predictions are fed to stack classifier as shown in table 658. Based on this, the overall prediction indicates candidate 2 with no disparity and hence the final candidate prediction is indicative of low variance and low bias.

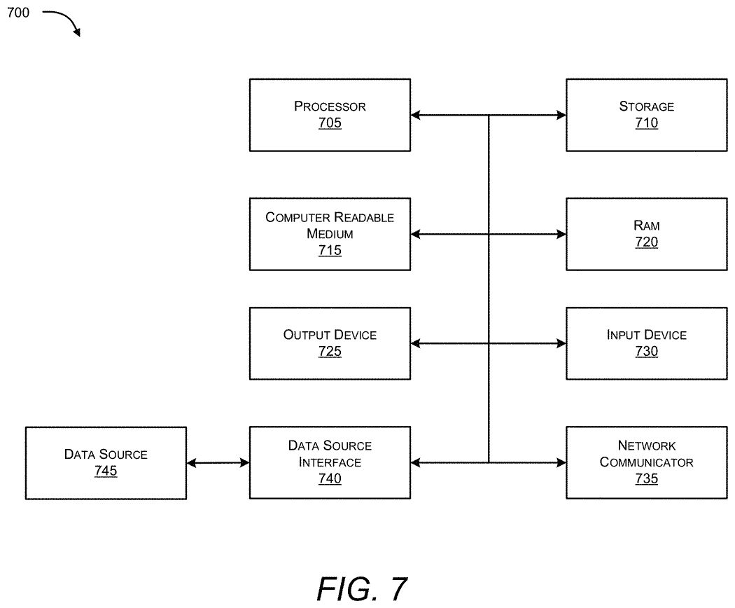

FIG. 7 illustrates a hardware platform 700 for implementation of the system 100, according to an example embodiment of the present disclosure. Particularly, computing machines, such as but not limited to internal/external server clusters, quantum computers, desktops, laptops, smartphones, tablets and wearables which may be used to execute the system 100 or may have the structure of the hardware platform 700. The hardware platform 700 may include additional components not shown and that some of the components described may be removed and/or modified. In another example, a computer system with multiple GPUs can sit on external-cloud platforms including Amazon Web Services, or internal corporate cloud computing clusters, or organizational computing resources, etc. In FIG. 7, the hardware platform 700 may be a computer system 700 that may be used with the examples described herein. The computer system 700 may represent a computational platform that includes components that may be in a server or another computer system. The computer system 700 may execute, by a processor (e.g., a single or multiple processors) or other hardware processing circuit, the methods, functions and other processes described herein. These methods, functions and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system 700 may include a processor 705 that executes software instructions or code stored on a non-transitory computer-readable storage medium 710 to perform methods of the present disclosure. The software code includes, for example, instructions to gather information pertaining risk factors and data elements in an environment and generate alerts, based on risk assessment of the environment. In an example, one or more of the data lake 106, the machine learning 108, the predictive analytics 110, and the intelligent automation 112 may be software codes or components performing these steps.

The instructions on the computer-readable storage medium 710 are read and stored the instructions in storage 715 or in random access memory (RAM) 720. The storage 715 provides a large space for keeping static data where at least some instructions could be stored for later execution. The stored instructions may be further compiled to generate other representations of the instructions and dynamically stored in the RAM 720. The processor 705 reads instructions from the RAM 720 and performs actions as instructed.

The computer system 700 further includes an output device 725 to provide at least some of the results of the execution as output including, but not limited to, visual information to users, such as external agents. The output device can include a display on computing devices. For example, the display can be a mobile phone screen or a laptop screen. GUIs and/or text are presented as an output on the display screen. The computer system 700 further includes input device 730 to provide a user or another device with mechanisms for entering data and/or otherwise interact with the computer system 700. The input device may include, for example, a keyboard, a keypad, a mouse, or a touchscreen. In an example, output of any of the data lake 106, the machine learning 108, the predictive analytics 110, and the intelligent automation 112 may be displayed on the output device 725. Each of these output devices 725 and input devices 730 could be joined by one or more additional peripherals. In an example, the output device 725 may be used to provide alerts or display a risk assessment map of the environment.

A network communicator 735 may be provided to connect the computer system 700 to a network and in turn to other devices connected to the network including other clients, servers, data stores, and interfaces, for instance. A network communicator 735 may include, for example, a network adapter, such as a LAN adapter or a wireless adapter. The computer system 700 includes a data source interface 740 to access data source 745. A data source is an information resource. As an example, a database of exceptions and rules may be a data source. Moreover, knowledge repositories and curated data may be other examples of data sources.

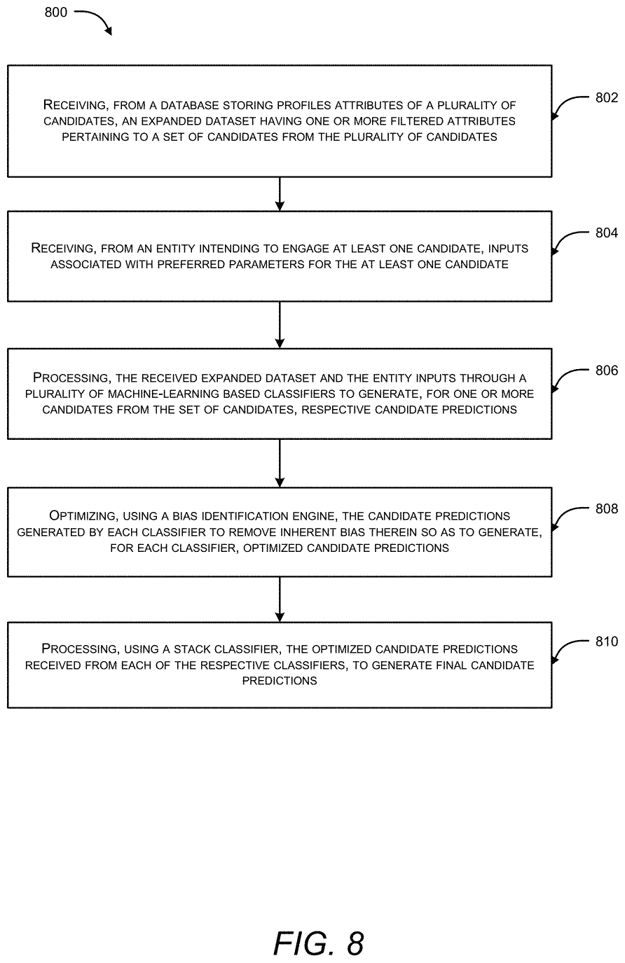

FIG. 8 illustrates a flow diagram for facilitating candidate acquisition method 800, according to an example embodiment of the present disclosure. At step 802, the method may include receiving, by a candidate engagement optimizer operatively coupled with a processor, from a database storing profiles attributes of a plurality of candidates, an expanded dataset having one or more filtered attributes pertaining to a set of candidates from the plurality of candidates. At step 804, the method may include receiving, by the candidate engagement optimizer, from an entity intending to engage at least one candidate, inputs associated with preferred parameters for the at least one candidate. At step 806, the method may include processing, by the candidate engagement optimizer, the received expanded dataset and the entity inputs through a plurality of machine-learning based classifiers to generate, for one or more candidates from the set of candidates, respective candidate predictions. At step 808, the method includes optimizing, by the candidate engagement optimizer, using a bias identification engine, the candidate predictions generated by each classifier to remove inherent bias therein so as to generate, for each classifier, optimized candidate predictions. At step 810, the method includes processing, by the candidate engagement optimizer, using a stack classifier, the optimized candidate predictions received from each of the respective classifiers, to generate final candidate predictions.

The order in which the steps of the method 800 are described is not intended to be construed as a limitation, and any number of the described method blocks may be combined or otherwise performed in any order to implement the method 800, or an alternate method. Additionally, individual blocks may be deleted from the methods 800 without departing from the spirit and scope of the present disclosure described herein. Furthermore, the method 800 may be implemented in any suitable hardware, software, firmware, or a combination thereof, that exists in the related art or that is later developed. The method 800 describe, without limitation, the implementation of the system 100. A person of skill in the art will understand that method 800 may be modified appropriately for implementation in various manners without departing from the scope and spirit of the disclosure.

What has been described and illustrated herein are examples of the present disclosure. One of ordinary skill in the art will appreciate that techniques consistent with the present disclosure are applicable in other contexts as well without departing from the scope of the disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

I/We claim:

1. A system comprising:
a candidate acquisition orchestration engine comprising:
a candidate engagement optimizer operatively coupled with a processor that causes the candidate engagement optimizer to:
receive, from a database storing profiles attributes of a plurality of candidates, an expanded dataset having one or more filtered attributes pertaining to a set of candidates from the plurality of candidates;
receive, from an entity intending to engage at least one candidate, inputs associated with preferred parameters for the at least one candidate;
process the received expanded dataset and the entity inputs through a plurality of machine-learning based classifiers to generate, for one or more candidates from the set of candidates, respective candidate predictions;
optimize, using a bias identification engine, the candidate predictions generated by each classifier to remove inherent bias therein so as to generate, for each classifier, optimized candidate predictions; and
process, using a stack classifier, the optimized candidate predictions received from each of the respective classifiers, to generate final candidate predictions.

2. The system as claimed in claim 1, wherein the set of candidates is identified from the plurality of candidates based on one or more of matching of candidate skills with the preferred parameters for the at least one candidate, candidate profile, interest and availability of the candidate, source from where the candidate profile is received, and background check assessment of the candidate.

3. The system as claimed in claim 1, wherein the expanded dataset is stored in a data lake associated with the system, the expanded dataset comprising at least one of candidate application tracking system (ATS) data, data associated with qualification, interest, and availability of the candidate, and the entity inputs associated with requirements for the candidates.

4. The system as claimed in claim 1, wherein the system comprises an automation engine to perform one or more automation steps pertaining to at least one of automated sourcing of advertisements of the engagement on predefined channels and automation related to entity specific action associated with the candidate acquisition.

5. The system as claimed in claim 1, wherein the bias identification engine removes bias associated with at least one of nationality, language, cultural tradition, gender, caste, creed, color, race, source of hire, disability status, sexual orientation, physical abilities, weight, age, name, height, educational background, birthplace, salary expectations, employment history, interviewer, potential to renege, religion, ethnicity, interview, location, and background check.

6. The system as claimed in claim 1, wherein the bias identification engine provides course correction to the respective classifiers by enabling bias removal while making the candidate predictions.

7. The system as claimed in claim 1, wherein the bias identification engine executes a bias identification algorithm to identify disparity in candidate predictions of each classifier, and optimizes the candidate predictions based on the entity inputs, wherein the final candidate predictions have low variance and low bias.

8. The system as claimed in claim 1, wherein the bias identification engine is trained using a machine learning algorithm.

9. The system as claimed in claim 1, wherein the classifier is selected from any of Bi Long Short-term Memory (Bi LSTM), Artificial Neural Network (ANN) based Classifier, Support Vector Machine (SVM), Reinforcement Learning (RL) based Classifier, Logistics Regression (LR) based Classifier, Decision Tree (DT) based classifier, Vector Space Model (VSM) based classifier, Random Forest (RF) based classifier, xExtreme Gradient Boosted Trees based classifier, and Light Gradient Boosting Machines (GBM).

10. The system as claimed in claim 1, wherein the entity inputs comprise at least one of a desired candidate profile, a diversity goal of the entity, an organization goal of the entity, and biases that the entity would desire to remove.

11. A method for facilitating candidate acquisition, the method comprising:
receiving, by a candidate engagement optimizer operatively coupled with a processor, from a database storing profiles attributes of a plurality of candidates, an expanded dataset having one or more filtered attributes pertaining to a set of candidates from the plurality of candidates;
receiving, by the candidate engagement optimizer, from an entity intending to engage at least one candidate, inputs associated with preferred parameters for the at least one candidate;
processing, by the candidate engagement optimizer, the received expanded dataset and the entity inputs through a plurality of machine-learning based classifiers to generate, for one or more candidates from the set of candidates, respective candidate predictions;
optimizing, by the candidate engagement optimizer, using a bias identification engine, the candidate predictions generated by each classifier to remove inherent bias therein so as to generate, for each classifier, optimized candidate predictions; and
processing, by the candidate engagement optimizer, using a stack classifier, the optimized candidate predictions received from each of the respective classifiers, to generate final candidate predictions.

12. The method as claimed in claim 11, wherein the set of candidates is identified from the plurality of candidates based on one or more of matching of candidate skills with the preferred parameters for the at least one candidate, candidate profile, interest and availability of the candidate, source from where the candidate profile is received, and background check assessment of the candidate.

13. The method as claimed in claim 11, wherein the expanded dataset comprises any or a combination candidate application tracking system (ATS) data, data associated with qualification, interest, and availability of the candidate, and the entity inputs associated with requirements for the candidates.

14. The method as claimed in claim 11, wherein the final candidate predictions have low variance and low bias.

15. The method as claimed in claim 11, wherein the bias identification engine removes bias associated with any or a combination of nationality, language, cultural tradition, gender, caste, creed, color, race, source of hire, disability status, sexual orientation, physical abilities, weight, age, name, height, educational background, birthplace, salary expectations, employment history, interviewer, potential to renege, religion, ethnicity, interview, location, and background check.

16. The method as claimed in claim 11, wherein the bias identification engine provides course correction to the respective classifiers by enabling bias removal while making the candidate predictions.

17. The method as claimed in claim 11, wherein the bias identification engine identifies disparity in candidate predictions of each classifier, and optimizes the candidate predictions based on the entity inputs, and wherein the bias identification engine is trained using a machine learning algorithm.

18. The method as claimed in claim 11, wherein the classifier is selected from any of Bi Long Short-term Memory (Bi LSTM), Artificial Neural Network (ANN) based Classifier, Support Vector Machine (SVM), Reinforcement Learning (RL) based Classifier, Logistics Regression (LR) based Classifier, Decision Tree (DT) based classifier, Vector Space Model (VSM) based classifier, Random Forest (RF) based classifier, xExtreme Gradient Boosted Trees based classifier, and Light Gradient Boosting Machines (GBM).

19. The method as claimed in claim 11, wherein the entity inputs comprise desired candidate profile, diversity goal of the entity, organization goal of the entity, and biases that the entity would desire to remove.

20. A non-transitory computer readable medium, wherein the readable medium comprises machine executable instructions that are executable by a processor to:
receive, from a database storing profiles attributes of a plurality of candidates, an expanded dataset having one or more filtered attributes pertaining to a set of candidates from the plurality of candidates;
receive, from an entity intending to engage at least one candidate, inputs associated with preferred parameters for the at least one candidate;
process the received expanded dataset and the entity inputs through a plurality of machine-learning based classifiers to generate, for one or more candidates from the set of candidates, respective candidate predictions;
optimize, using a bias identification engine, the candidate predictions generated by each classifier to remove inherent bias therein so as to generate, for each classifier, optimized candidate predictions; and
process, using a stack classifier, the optimized candidate predictions received from each of the respective classifiers, to generate final candidate predictions.
